(19) United States
(12) Patent Application Publication
(10) Pub. No.: US 2014/0280050 A1
(43) Pub. Date: Sep. 18, 2014

(54) TERM SEARCHING BASED ON CONTEXT

(71) Applicant: FUJITSU LIMITED, Kawasaki-shi (JP)

(72) Inventors: Naomi HADATSUKI, San Jose, CA (US); Mitsuru TOMONO, San Jose, CA (US)

(73) Assignee: FUJITSU LIMITED, Kawasaki-shi (JP)

(21) Appl. No.: 13/830,412

(22) Filed: Mar. 14, 2013

(51) Int. Cl. G06F 17/30

(52) U.S. Cl. CPC G06F 17/30528
USPC 707/722

(57) ABSTRACT

A method of performing a context based search associated with a digital document may include determining a contextual keyword associated with the digital document. The contextual keyword may be determined based on one or more of content included in the digital document and information associated with the digital document. Additionally, the contextual keyword may provide context to use of a term in the digital document such that the contextual keyword may indicate a meaning of the term as the term is used in the digital document. The method may further include initiating a context based search of a general information database using the term and the contextual keyword such that a result of the context based search may indicate the meaning of the term as the term is used in the digital document.

### FIELD

The present disclosure relates to performing searches associated with a term based on contextual use of the term.

### BACKGROUND

Many written documents, such as books, are available in a digital form (referred to as “digital documents”) and may be read using an electronic reader (commonly referred to as an “e-reader”) included on an electronic device. Sometimes an e-reader may allow a user to select a term in the digital document and perform a search associated with the term, such as the definition of the term.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of performing a context based search associated with a digital document may include determining a contextual keyword associated with the digital document. The contextual keyword may be determined based on one or more of content included in the digital document and information associated with the digital document. Additionally, the contextual keyword may provide context to use of a term in the digital document such that the contextual keyword may indicate a meaning of the term as the term is used in the digital document. The method may further include initiating a context based search of a general information database using the term and the contextual keyword such that a result of the context based search may indicate the meaning of the term as the term is used in the digital document.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example system for performing a context based search; and

FIG. 2 is a flow chart of an example method of performing a context based search.

### DESCRIPTION OF EMBODIMENTS

According to some embodiments described herein, an electronic reader (referred to hereinafter as an “e-reader”) may be configured to allow a user to view a digital document. The e-reader may also be configured to allow the user to request further information regarding a term included in the digital document. For example, the e-reader may be configured to search for a definition of a particular term. In some embodiments, the e-reader may be configured to determine one or more contextual keywords that may be associated with the term such that the contextual keywords may give context to the use of the term. Accordingly, the contextual keywords may indicate a meaning of the term as the term is used in the digital document.

For example, a definition or connotation of a term may depend on how the term is used with respect to a situation in which the term is used. Additionally, the same term may have different meanings in different locations, different time periods, among different cultures, and in different settings. Therefore, in some embodiments, the contextual keywords may indicate the situation, the location, the time period, the culture, and/or the setting in which the term is used such that a more accurate meaning of the term may be determined.

The e-reader of the present disclosure may be configured to determine one or more contextual keywords associated with a term used within a digital document. In some embodiments, the contextual keywords may include people, landmarks, events, and/or an era associated with content of the digital document. In these and other embodiments, the contextual keywords may also include a publication year of the digital document, an author of the digital document, and/or a genre of the digital document. As discussed in detail below, the e-reader may be configured to initiate a search (e.g., an Internet search with a search engine) using a term and one or more contextual keywords associated with the term, which may be referred to hereinafter as a “context based search.” The use of the term and one or more contextual keywords in the context based search may yield search results that relate the term to the contextual keywords. Therefore, a more accurate representation of the intended meaning of the term as used in the digital document may be determined than in instances where only the term itself is used to perform a search associated with the term.

FIG. 1 illustrates an example system 100 for performing a context based search, arranged in accordance with at least some embodiments described herein. The system 100 may include an electronic device 102. The electronic device 102 may include any suitable system, apparatus, or device configured to allow a user to view a digital document 112. The electronic device 102 may also be configured to perform a context based search associated with one or more terms included in the digital document 112. In the illustrated embodiment, the electronic device 102 may include an e-reader 104 configured to perform one or more operations involved in viewing the digital document 112 and performing context based searches with respect to the digital document 112.

The e-reader 104 may be implemented by any suitable mechanism, such as a program, software, function, library, software-as-a-service, analog or digital circuitry, or any combination thereof. The electronic device 102 may also include a processor 114 coupled to a memory 116. In some embodiments, the e-reader 104 may be embodied in logic or instructions resident in the memory 116 for execution by the processor 114.

The processor 114 may include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor 114 may interpret and/or execute program instructions and/or process data stored in the memory 116.

The memory 116 may include any suitable computer-readable media configured to retain program instructions and/or data for a period of time. By way of example, and not limitation, such computer-readable media may include tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), a specific molecular sequence (e.g., DNA or RNA) or any other storage medium which may be used to carry or store desired program code in the form of computer-executable instructions or data structures and which may be accessed by the processor 114. Combinations of the above may also be included within the scope of computer-readable media. Computer-executable instructions may include, for example, instructions and data that cause a general purpose computer, special purpose computer, or special purpose processing device (e.g., the processor 114) to perform a certain function or group of functions.

The digital document 112 may include any suitable document that may be in a digital form and that may be interpreted by the e-reader 104. The digital document 112 may be displayed by the e-reader 104 via a display 118 of the electronic device 102 such that the digital document 112 may be viewed by a user of the electronic device 102. For example, the digital document may be a digitized electronic book, article, journal, magazine, or any other written media that may be in a digital form and stored in any appropriate format. In some embodiments, the digital document 112 may be stored in a computer-readable medium associated with the electronic device 102, such as in the memory 116. In these or other embodiments, the digital document 112 may be stored remotely from the electronic device 102, but may be accessed by the electronic device 102 and the e-reader 104 via any suitable manner, such as via a network 122.

The e-reader 104 may include a contextual keyword module 106, a term selection module 108, a combining module 110, and a results module 111. The contextual keyword module 106 may be configured to determine contextual keywords associated with the digital document 112. For example, in some embodiments, the contextual keyword module 106 may be configured to scan content of the digital document 112 to determine contextual keywords based on words that may provide context to material of the digital document 112 being presented to a user by way of the e-reader 104. The contextual keywords determined from the content may be, by way of example and not limitation, a person (e.g., a main or sub-character) included in the digital document 112, a location (e.g., city) included in the digital document 112, a landmark (e.g., Big Ben, the Eiffel tower) included in the digital document 112, an event (e.g., World War II, Gilroy garlic festival) included in the digital document 112, or a time period (e.g., the Victorian era) in which the content of the digital document 112 is set. In some embodiments, the contextual keyword module 106 may determine the contextual keywords from a page, or a number of pages before and/or after a page of the digital documents 112 that is currently being presented on the display 118.

In some embodiments, the contextual keyword module 106 may be configured to determine the contextual keywords from the content of the digital document 112 based on proper nouns included in the digital document 112. For example, the contextual keyword module 106 may be configured to scan words included in the digital document 112 and enter the words into an electronic dictionary. The electronic dictionary may indicate which of the words are proper nouns and the contextual keyword module 106 may designate one or more of the proper nouns as contextual keywords. In some embodiments, the electronic dictionary may be stored in the memory 116 of the electronic device 102. In some embodiments, the electronic dictionary may be stored elsewhere and accessed by the contextual keyword module 106 via the network 122. Therefore, in some embodiments, the contextual keyword module 106 may be configured to determine the contextual keywords based on content included in the digital document 112.

The contextual keyword module 106 may also be configured to determine the contextual keywords based on attributes of the digital document 112. For example, the contextual keyword module 106 may be configured to determine a publication year, a publication date, an author, a genre, and/or any other suitable attribute of the digital document 112. The contextual keyword module 106 may accordingly determine one or more contextual keywords based on one or more attributes of the digital document 112 that may indicate an intended meaning of a term included in the digital document 112.

In some embodiments, the contextual keyword module 106 may compile the determined contextual keywords into a list of contextual keyword candidates. In some of these embodiments, the list of contextual keyword candidates may be presented to a user via the display 118 such that the user may select which contextual keywords may be used in a context based search. In some embodiments, the contextual keyword module 106 may select one or more of the contextual keywords of the list of contextual keyword candidates that may be used in the context based search without receiving input from the user.

The term selection module 108 may be configured to select one or more terms included in the digital document 112 that may be the main subject of a context based search. In some embodiments, the term selection module 108 may select a term based on an input from the user indicating that the user wants more information related to the term. For example, in some embodiments, the display 118 may include a touch-screen and the user may touch the term on the display 118. The term selection module 108 may accordingly select the term for use in a context based search in response to the user touching the term on the display 118. The term selection module 108 may also select the term in response to any other input by the user such as clicking on and/or highlighting the term with a mouse or some other user interface.

In some embodiments, the term selection module 108 may be configured to determine search term candidates that may be used as the term in the context based search. The search term candidates may include nouns and verbs included in the text of the digital document 112 that may be likely terms of which the user may desire more information, such as terms for which a user may likely want to know the definition. In some embodiments, the term selection module 108 may be configured to enter the words included in the digital document 112 into the electronic dictionary that may also be used by the contextual keyword module 106. The electronic dictionary may indicate which of the words are nouns or verbs and the term selection module 108 may select one or more of the nouns or verbs as search term candidates. In some embodiments, the term selection module 108 may compile the search term candidates into a list of search term candidates.

The combining module 110 may be configured to receive the list of contextual keyword candidates from the contextual keyword module 106. The combining module 110 may also be configured to receive a term selected by the user and/or the term selection module 108 and/or receive the list of search term candidates from the term selection module 108. The combining module 110 may be configured to combine one or more of the contextual keywords included in the list of contextual keyword candidates with the term selected by the user and/or the term selection module 108 and/or with one or more of the search term candidates included in the list of search term candidates. In some embodiments, the combining module 110 may include the different combinations of contextual keyword candidates and search term candidates in a list of searching combinations.

The combining module 110 may be configured to initiate the context based search, where the context based search may include one or more combinations of contextual keyword candidates and search term candidates. In some embodiments, the combining module may initiate the context based search such that the context based search is performed with respect to a general information database of broad information that may not be limited to information about or the content of the digital document 112 (e.g., the Internet). For example, in some embodiments, the combining module 110 may be configured to initiate the context based search using a search engine 124 configured to search the general information database.

The search engine 124 may be any suitable search engine that may provide results for the context based search. By way of example and not limitation, the search engine 124 may be a commercial search engine such as Google®, Bing®, Yahoo®, etc. that may search the Internet using the contextual keyword and the term. In some embodiments, the combining module 110 may be configured to initiate the context based search in the search engine 124 via a network interface 120 of the electronic device 102 and the network 122. In some embodiments, the combining module 110 may be configured to initiate the context based search based on the selection of the term by the user. In these and other embodiments, the combining module 110 may be configured to initiate the context based search in response to the user indicating a desire to perform a search, but without having selected a term for the desired search.

In some embodiments, the combining module 110 may present the list of searching combinations to the user in response to the user indicating a desire to perform a search (e.g., by selecting a term to be searched or indicating a general desire to perform a search). The user may accordingly select which combination the user wants to use in a context based search and the combining module 110 may initiate the context based search in the search engine 124 based on the selected combination.

The results module 111 may be configured to extract the results of the context based search that may be generated by the search engine 124. The results module 111 may also be configured to present the results on the display 118 such that the user may view the results. In some embodiments, the results module 111 may be configured to query the user, via the display 118, if the user is satisfied with the results. If the user is not satisfied with the results, the results module 111 may direct the combining module 110 to present one or more other combinations from the list of searching combinations to the user such that the user may select another combination for another context based search. In these or other embodiments, the results module 111 may direct the combining module 110 to automatically initiate another context based search using another combination from the list of searching combinations.

If the user is satisfied with the results, in some embodiments, the results module 111 may save the results for future reference. For example, the results module 111 may save the results in the memory 116 such that the user may retrieve the results at a later time. In some embodiments, the results module 111 may query, via the display 118, whether or not the user desires to save the search results for future reference. If the user indicates a desire to save the results, the results module 111 may do so. Additionally, in some embodiments, if another user is reading the digital document 112 and desires to perform the same or a similar search as that associated with the saved results, the combining module 110 may retrieve the stored results in response to an indication to perform the search instead of initiating another search. The results module 111 may accordingly present the results to the user retrieved from the memory 116.

Accordingly, in some embodiments, the combining module 110 may be configured to determine whether results associated with a similar search are already saved in the memory 116 before initiating a search via the search engine 124. Additionally, in some embodiments, the combining module 110 may automatically initiate one or more context based searches based on one or more searching combinations included in the list of searching combination candidates. In these and other embodiments, the results module 111 may automatically store the results in the memory 116 such that the results may be retrieved at a later time if the same, or a similar search is desired by the user.

Therefore, the system 100 may be configured to perform context based searches for terms included in the digital document 112. The context based searches may provide more accurate results relating to the meaning and connotation of terms as used in the digital document 112. In contrast, current methods for providing meaning of terms in a digital document merely perform searches related to the term without providing context.

Modifications, additions, or omissions may be made to the system 100 without departing from the present disclosure. For example, the order of many operations may be different than described above. Additionally, the functions of one or more of the modules and/or other components listed above may be performed by other components or modules than those specifically listed and a single module or component may perform the operations associated with more than one of the above described modules and components. The different modules and components are merely used to clarify the different operations that may be performed by the system 100.

FIG. 2 is a flow chart of an example method 200 of performing a context based search, arranged in accordance with at least some embodiments described herein. The method 200 may be implemented, in some embodiments, by an electronic device, such as the electronic device 102 of FIG. 1. For instance, the e-reader 104 of the electronic device 102 of FIG. 1 may be configured to execute computer instructions to perform operations for performing a context based search as represented by one or more of blocks 202 and/or 204 of the method 200. Although illustrated as discrete blocks, various blocks may be divided into additional blocks, combined into fewer blocks, or eliminated, depending on the desired implementation.

The method 200 may begin at block 202, where a contextual keyword associated with a digital document may be determined. As mentioned above, the contextual keyword may provide context to use of a term in the digital document such that the contextual keyword may indicate a meaning of the term as the term is used in the digital document. In some embodiments, the contextual keyword may be determined based on content included in the digital document and/or information associated with the digital document. In some embodiments, the content of the digital document may be searched to determine at least one of a person, a location, a landmark, an event, and an era associated with the content of the digital document, where at least one of which may be used as the contextual keyword. Additionally, the information associated with the digital document may include at least one of a publication year, an author, and a genre of the digital document. Further, in some embodiments, multiple contextual keywords may be determined and a list of contextual keyword candidates that includes one or more of the contextual keywords may be generated.

In block 204, a context based search of a general information database may be initiated. As mentioned above, the general information database may include a broad range of information that may not be limited to the contents of the digital document (e.g., the Internet). In some embodiments, the context based search may be initiated using a search engine that may be configured to search the general information database. The context based search may be for a term included in the digital document and may be based on the term and one or more of the contextual keywords. As mentioned above, in some instances, the term may be selected for searching based on an input received from a user while in other instances, the term may be selected by without user input, for example, by an e-reader. Additionally, in some embodiments, a list of search term candidates may be generated (e.g., by the e-reader) and the term may be extracted from the list of search term candidates. Additionally, in some embodiments, the context based search may be based on the term and the contextual keyword in response to a user input to use the term and the contextual keyword in the context based search.

Therefore, the method 200 may be used to perform a context based search of a term included in the digital document. The context based search may yield search results that are more accurate than other searches because the search may take into consideration the context with which the term is being used in the digital document.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 200 may further include steps associated with generating a list of possible combinations of terms and contextual keywords that may be used in a context based search and steps associated with performing a context based search using one of the combinations based on a selection of the combination. Further, in some embodiments, the method 200 may include steps associated with presenting a result of the context based search to the user, querying the user if the user is satisfied with the results and performing another context based search if the user is not satisfied with the results. Additionally, the method 200 may include steps associated with storing the results of the context based search and/or retrieving the results at another time.

As described above, the embodiments described herein may include the use of a special purpose or general-purpose computer including various computer hardware or software modules, as discussed in greater detail below.

Further, as indicated above, embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may comprise tangible computer-readable storage media including RAM, ROM, EEPROM, CD-ROM or other optical disk storage, magnetic disk storage or other magnetic storage devices, a molecular sequence (e.g., DNA or RNA), or any other storage medium which may be used to carry or store desired program code in the form of computer-executable instructions or data structures and which may be accessed by a general purpose or special purpose computer. Combinations of the above may also be included within the scope of computer-readable media.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the disclosure.

What is claimed is:

1. A method of performing a context based search associated with a digital document, the method comprising:
determining a contextual keyword associated with a digital document based on one or more of content included in the digital document and information associated with the digital document, the contextual keyword providing context to use of a term in the digital document such that the contextual keyword indicates a meaning of the term as the term is used in the digital document; and
initiating a context based search of a general information database using the term and the contextual keyword, a result of the context based search indicating the meaning of the term as the term is used in the digital document.

2. The method of claim 1, further comprising selecting the term based on an input received from a user.

3. The method of claim 1, further comprising:
generating a list of search term candidates based on text included in the digital document; and
extracting the term from the list of search term candidates.

4. The method of claim 3, further comprising:
presenting the list of search term candidates to a user; and
extracting the term from the list of search term candidates based on a selection of the term from the list of search term candidates by the user.

5. The method of claim 1, further comprising using the term and the contextual keyword in the context based search in response to a user input to use the term and the contextual keyword in the context based search.

6. The method of claim 1, wherein the information associated with the digital document includes one or more of a publication year of the digital document, an author of the digital document, and a genre of the digital document.

7. The method of claim 1, wherein determining the contextual keyword based on the content of the digital document includes searching the content of the digital document to determine one or more of a person, a location, a landmark, an event, and an era associated with the content of the digital document.

8. The method of claim 1, further comprising:
generating a list of contextual keyword candidates based on one or more of the content included in the digital document and the information associated with the digital document; and
extracting the contextual keyword from the list of contextual keyword candidates.

9. The method of claim 1, further comprising:
generating a search list of a plurality of searching combinations that each include a contextual keyword candidate and a search term candidate; and
initiating the context based search in response to a selection of a searching combination from the plurality of searching combinations where the search term candidate of the selected searching combination is the term and the contextual keyword candidate of the selected searching combination is the contextual keyword.

10. The method of claim 1, wherein initiating the context based search of the general information database comprises initiating the context based search using a search engine configured to search the general information database.

11. A processor configured to execute computer instructions to cause a system to perform operations for performing a context based search, the operations comprising:
determining a contextual keyword associated with a digital document based on one or more of content included in the digital document and information associated with the digital document, the contextual keyword providing context to use of a term in the digital document such that the contextual keyword indicates a meaning of the term as the term is used in the digital document; and
initiating a context based search of a general information database using the term and the contextual keyword, a result of the context based search indicating the meaning of the term as the term is used in the digital document.

12. The processor of claim 11, wherein the operations further comprise selecting the term based on an input received from a user.

13. The processor of claim 11, wherein the operations further comprise:
generating a list of search term candidates based on text included in the digital document; and
extracting the term from the list of search term candidates.

14. The processor of claim 11, wherein the operations further comprise:
presenting the list of search term candidates to a user; and
extracting the term from the list of search term candidates based on a selection of the term from the list of search term candidates by the user.

15. The processor of claim 11, wherein the operations further comprise using the term and the contextual keyword in the context based search in response to a user input to use the term and the contextual keyword in the context based search.

16. The processor of claim 11, wherein the information associated with the digital document includes one or more of a publication year of the digital document, an author of the digital document, and a genre of the digital document.

17. The processor of claim 11, wherein determining the contextual keyword based on the content of the digital document includes searching the content of the digital document to determine one or more of a person, a location, a landmark, an event, and an era associated with the content of the digital document.

18. The processor of claim 11, wherein the operations further comprise:
generating a list of contextual keyword candidates based on one or more of the content included in the digital document and the information associated with the digital document; and
extracting the contextual keyword from the list of contextual keyword candidates.

19. The processor of claim 11, wherein the operations further comprise:
generating a search list of a plurality of searching combinations that each include a contextual keyword candidate and a search term candidate; and
initiating the context based search in response to a selection of a searching combination from the plurality of searching combinations where the search term candidate of the selected searching combination is the term and the contextual keyword candidate of the selected searching combination is the contextual keyword.

20. The processor of claim 11, wherein initiating the context based search of the general information database comprises initiating the context based search using a search engine configured to search the general information database.
